(19) United States
(12) Patent Application Publication
(10) Pub. No.: US 2026/0074845 A1
(43) Pub. Date: Mar. 12, 2026

(54) Unified Transmission Configuration Indication States for Multipoint Downlink Operation Using Single Control Information

(71) Applicant: Apple Inc., Cupertino, CA (US)

(72) Inventors: Haitong Sun, Saratoga, CA (US); Dawei Zhang, Saratoga, CA (US); Ankit Bhamri, Haar (DE); Wei Zeng, Saratoga, CA (US); Hong He, San Jose, CA (US); Oghenekome Oteri, San Diego, CA (US); Chunhai Yao, Beijing (CN)

(21) Appl. No.: 19/102,301

(22) PCT Filed: Sep. 22, 2022
(86) PCT No.: PCT/CN2022/120555

§ 371 Date: Feb. 7, 2025

(51) Int. Cl. H04L 5/00

(52) U.S. Cl. CPC H04L 5/0044; H04L 5/0053

(57) ABSTRACT

This disclosure relates to techniques for performing multi-transmission and reception point operation in a wireless communication system. A network may provide configuration and/or mode information for selecting transmission control indication states. A plurality of transmission control indication states may be activated. One or more states may be selected for performing downlink operation.

### FIELD

The present application relates to wireless communications, and more particularly to systems, apparatuses, and methods for communication using unified transmission control states for multi-transmission-reception-point operation in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for communication using unified transmission control states for multi-transmission-reception-point operation in a wireless communication system.

One set of embodiments may include a method, by a user equipment (UE). The method may include receiving, from a cellular network, configuration of a plurality of transmission configuration indication (TCI) states associated with a plurality of transmission and reception points (TRPs). The UE may receive, from the cellular network, an indication of a plurality of active TCI states for downlink (DL) communication, wherein the plurality of active TCI states comprises a subset of the plurality of TCI states. The UE may receive, from the cellular network, an indication of a first mode, of a plurality of modes, for selection of one or more TCI state for DL operation. The UE may receive, from the cellular network, a first message scheduling a first DL transmission. The UE may select, based at least in part on the first mode, a first TCI state of the plurality of active TCI states for reception of the first DL transmission; and may receive the first DL transmission from at least a first TRP of the plurality of TRPs.

One set of embodiments may include a method, by a user equipment (UE). The method may include receiving, from a cellular network, configuration of a plurality of transmission configuration indication (TCI) states associated with a plurality of transmission and reception points (TRPs). The UE may receive, from the cellular network, an indication of a plurality of active TCI states for downlink (DL) communication, wherein the plurality of active TCI states comprises a subset of the plurality of TCI states. The UE may receive, from the cellular network, configuration of a first resource group for DL control communication operation. The configuration of the first resource group may comprise an indication of a rule to select a TCI state for monitoring the first resource group. The UE may select, based at least in part on the configuration of the first resource group, a first TCI state of the plurality of active TCI states for monitoring the first resource group; and may monitor a control channel on the first resource group using the first TCI state.

One set of embodiments may include a method, by a user equipment (UE). The method may include receiving, from a cellular network, configuration of a plurality of transmission configuration indication (TCI) states associated with a plurality of transmission and reception points (TRPs). The UE may receive, from the cellular network, an indication of a plurality of active TCI states for downlink (DL) communication, wherein the plurality of active TCI states comprises a subset of the plurality of TCI states. The UE may receive, from the cellular network, an indication of a rule to select a TCI state for receiving channel state information (CSI) reference signals (CSI-RS). The UE may select, based at least in part on the rule, a first TCI state of the plurality of active TCI states for receiving CSI-RS. The UE may receive CSI-RS using the first TCI state from a first TRP of the plurality of TRPs.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings.

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 is a communication flow diagram illustrating aspects of an exemplary possible method for communication using unified transmission control states for multi-TRP operation in a wireless communication system, according to some embodiments.

FIGS. 6-16 illustrate exemplary aspects of various possible approaches to communication using unified transmission control states for multi-TRP operation in a wireless communication system, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive.
RAT: Radio Access Technology.
PDCCH: Physical Downlink Control Channel
TRP: Transmission-Reception-Point
TCI: Transmission Control Indicator
QCL: Quasi-co-located
DCI: Downlink Control Information
CSI: Channel State Information
CQI: Channel Quality Indicator
DL: Downlink

### Terms

The following is a glossary of terms that may appear in the present disclosure:
Memory Medium—Any of various types of non-transitory memory devices or storage devices. The term “memory medium” is intended to include an installation medium, e.g., a CD-ROM, floppy disks, or tape device: a computer system memory or random access memory such as DRAM, DDR RAM, SRAM, EDO RAM, Rambus RAM, etc.; a non-volatile memory such as a Flash, magnetic media, e.g., a hard drive, or optical storage: registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Computer System (or Computer)—any of various types of computing or processing systems, including a personal computer system (PC), mainframe computer system, workstation, network appliance. Internet appliance, personal digital assistant (PDA), television system, grid computing system, or other device or combinations of devices. In general, the term “computer system” may be broadly defined to encompass any device (or combination of devices) having at least one processor that executes instructions from a memory medium.
User Equipment (UE) (or “UE Device”)—any of various types of computer systems or devices that are mobile or portable and that perform wireless communications. Examples of UE devices include mobile telephones or smart phones (e.g., iPhone™. Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.
Wireless Device—any of various types of computer systems or devices that perform wireless communications. A wireless device can be portable (or mobile) or may be stationary or fixed at a certain location. A UE is an example of a wireless device.
Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.
Base Station (BS)—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
Automatically—refers to an action or operation performed by a computer system (e.g., software executed by the computer system) or device (e.g., circuitry, programmable hardware elements. ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

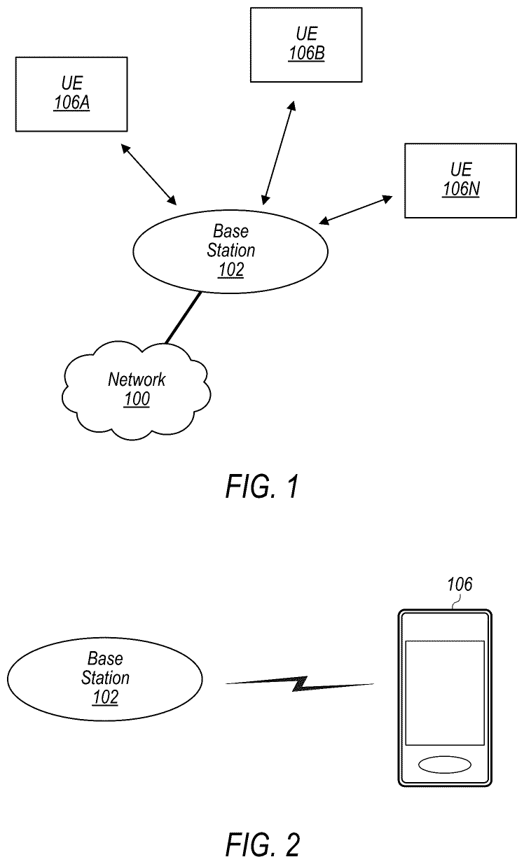

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink (UL) and downlink (DL) communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U. 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for communication using unified TCI states for multi-TRP operation in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

In some embodiments, the UE 106 may include multiple subscriber identity modules (SIMs, sometimes referred to as SIM cards). In other words, the UE 106 may be a multi-SIM (MUSIM) device, such as a dual-SIM device. Any of the various SIMs may be physical SIMs (e.g., SIM cards) or embedded (e.g., virtual) SIMs. Any combination of physical and/or virtual SIMs may be included. Each SIM may provide various services (e.g., packet switched and/or circuit switched services) to the user. In some embodiments. UE 106 may share common receive (Rx) and/or transmit (Tx) chains for multiple SIMs (e.g., UE 106 may have a dual SIM dual standby architecture). Other architectures are possible. For example, UE 106 may be a dual SIM dual active architecture, may include separate Tx and/or Rx chains for the various SIMs, may include more than two SIMs, etc.

The different identities (e.g., different SIMs) may have different identifiers, e.g., different UE identities (UE IDs). For example, an international mobile subscriber identity (IMSI) may be an identity associated with a SIM (e.g., in a MUSIM device each SIM may have its own IMSI). The IMSI may be unique. Similarly, each SIM may have its own unique international mobile equipment identity (IMEI). Thus, the IMSI and/or IMEI may be examples of possible UE IDs, however other identifiers may be used as UE ID.

The different identities may have the same or different relationships to various public land mobile networks (PLMNs). For example, a first identity may have a first home PLMN, while a second identity may have a different home PLMN. In such cases, one identity may be camped on a home network (e.g., on a cell provided by BS 102) while another identity may be roaming (e.g., while also camped on the same cell provided by BS 102, or a different cell provided by the same or different BS 102). In other circumstances, multiple identities may be concurrently home (e.g., on the same or different cells of the same or different networks) or may be concurrently roaming (e.g., on the same or different cells of the same or different networks). As will be appreciated, numerous combinations are possible. For example, two SIM subscriptions on a MUSIM device may belong to the same equivalent/carrier (e.g., AT&T/AT&T or CMCC/CMCC). As another exemplary possibility. SIM-A may be roaming into SIM-B's network (SIM-A CMCC user roaming into AT&T and SIM-B is also AT&T).

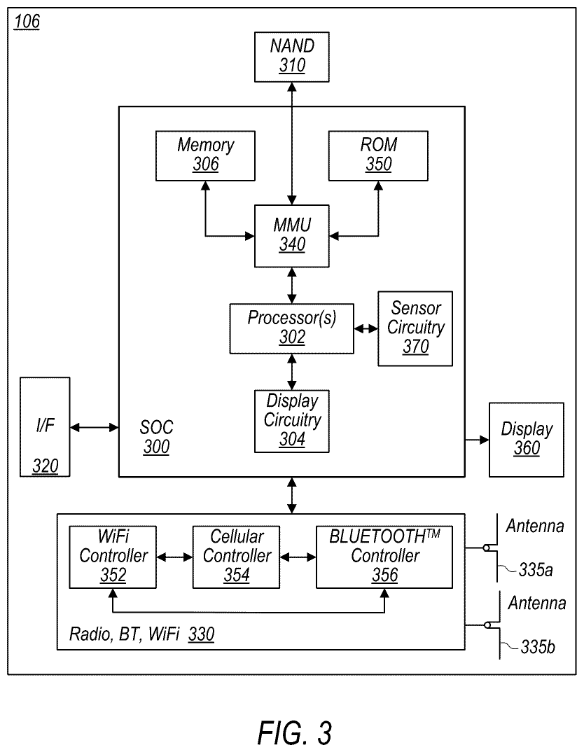

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340) may be included as a portion of the processor(s) 302.

As shown, the SOC 300 may be coupled to various other circuits of the UE 106. For example, the UE 106 may include various types of memory (e.g., including NAND flash 310), a connector interface 320) (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for communication using unified TCI states for multi-TRP operation in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for communication using unified TCI states for multi-TRP operation in a wireless communication system according to various embodiments disclosed herein. Processor(s) 302 may also implement various other applications and/or end-user applications running on UE 106.

In some embodiments, radio 330) may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

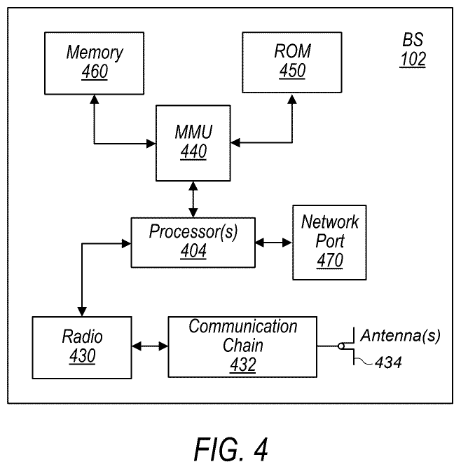

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New: Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Reference Signals

A wireless device, such as a user equipment, may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource group for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be provided

As a detailed example, in the 3GPP NR cellular communication standard, the channel state information fed back from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a low channel coding rate. As another example, when the downlink channel communication quality between the base station and the UE is determined to be low, the UE may feed back a low CQI value, which may cause the base station to transmit data using a relatively low modulation order and/or a high channel coding rate.

PMI feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g. when the base station and the UE have multiple antennas, which may enable multi-layer transmission through spatial multiplexing. The RI and the PMI may collectively allow the base station to know which precoding needs to be applied to which layer, e.g., depending on the number of transmission lavers.

In some cellular systems, a PMI codebook is defined depending on the number of transmission layers. In other words, for R-layer transmission. N number of Nₜ×R matrixes may be defined (e.g., where R represents the number of layers, Nₜ represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data lavers are also possible, according to various embodiments.

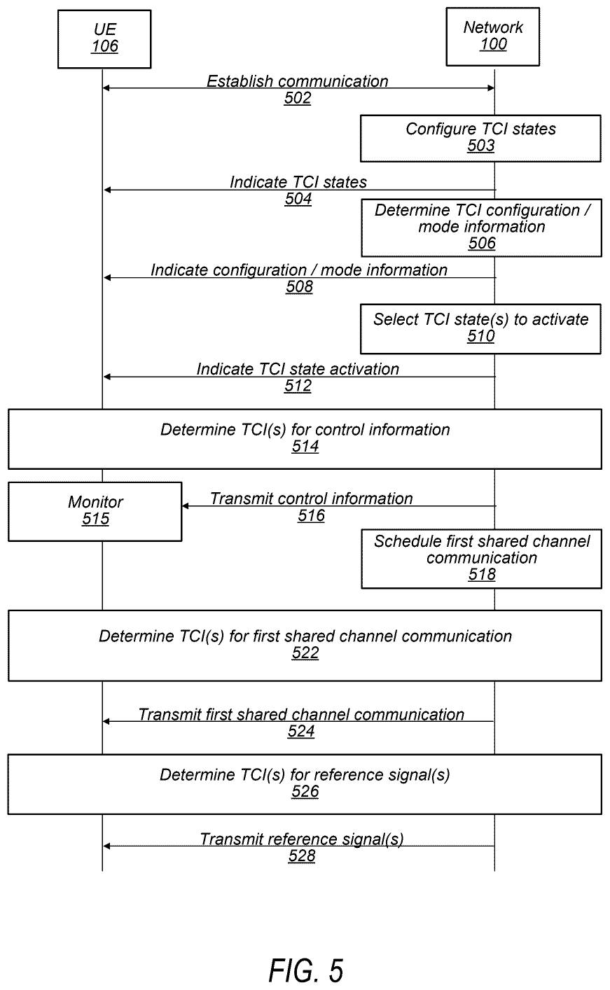

FIG. 5—TCI states for Multi-TRP Operation

According to some cellular communication technologies, it may be possible for a UE to communicate with multiple transmission-reception-points (TRPs), including potentially simultaneously. Such communication can be scheduled using downlink control information (DCI), which may be provided using control signaling such as on a physical downlink control channel (PDCCH) that may be transmitted in one or more control resource groups (CORESETs) and/or search space sets (SSSs). The DCI may be provided in a single DCI (sDCI) mode, in which communications between multiple TRPs (mTRP) and a wireless device/UE may be scheduled using a single DCI communication/message (e.g., from just one TRP), or in a multi-DCI mode, in which each of multiple TRPs may provide DCI communications scheduling their own communications with a wireless device. In some embodiments, in a single DCI mode, a single DCI message may be transmitted from multiple TRPs (e.g., each TRP may transmit the same DCI message).

The communications that are scheduled in such a multi-TRP scenario may include data communications (e.g., which may be transmitted using a physical downlink shared channel (PDSCH) and/or a physical uplink shared channel (PUSCH), and/or channel state information reference signal (CSI-RS) transmissions (e.g., periodic, semi-persistent, and/or aperiodic), among various possibilities. Further, CSI-RS transmissions can include CSI-RS that are configured for multiple possible purposes, such as for beam management, tracking, or CSI acquisition.

Transmission to/from a UE from/to a TRP may be directed according to a transmission control indication (TCI) state. For example, a TCI state may correspond to an uplink (UL) and/or downlink (DL) beam at the UE and/or TRP. A TCI state may be one of three types: uplink (e.g., only), downlink, or joint (e.g., bi-directional, e.g., uplink and downlink).

A UE may be configured to use one or more TCI states simultaneously. A few years after the first deployment of NR, the TCI state framework in Release 15 (Rel-15) may be considered overly flexible, which may lead to a significant signaling overhead. A unified TCI framework was introduced in Rel-17 which may facilitate streamlined multi-beam operation, e.g., for use with frequency range (FR) 1 and frequency range (FR) 2. According to the unified TCI framework, one TCI state indication may apply to multiple channels (e.g., PDSCH and PDCCH may be mapped to a single common DL TCI state: similarly, PUSCH and PUCCH may be mapped to a single common UL TCI state: or all of these channels may be mapped to a single common joint TCI state, among various possibilities).

One objective of various technical efforts may be to enhance the unified TCI framework to allow for extension to mTRP use cases. The Rel-17 unified TCI framework may support cases where all uplink and downlink signals/channels use the same beam or TCI. Similarly, the Rel-17 unified TCI framework may support cases where all uplink signals/channels use one beam/TCI and all downlink signals/channels use a second beam/TCI. However, the Rel-17 unified TCI framework may not support mTRP cases, e.g., where all uplink or downlink signals/channels do not use the same beam/TCI.

NR may support at least the following multi-TRP schemes:

Rel-16 Multi-DCI Multi-TRP: PDSCH and PUSCH:

Rel-16 Single-DCI multi-TRP: PDSCH schemes, including: spatial domain multiplexing (SDM), frequency division multiplexing (FDM) schemes A and B (fdmSchemeA, fdmSchemeB), time division multiplexing (TDM) schemes A and B (tdmSchemeA, tdmSchemeB (inter-slot)):

Rel-17 Multi-TRP: PDCCH schemes including: PDCCH repetition via SearchSpace linkage, and single frequency network (SFN) schemes e.g., SFN-PDCCH: sfnSchemeA, sfnSchemeB:

Rel-17 Single-DCI multi-TRP: PDSCH, e.g., SFN-PDSCH: sfnSchemeA, sfnSchemeB;

Rel-17 Single-DCI multi-TRP: PUSCH/PUCCH, e.g., PUSCH TDM repetition, PUCCH TDM repetition.

To illustrate one set of possible techniques for additional schemes, FIG. 5 is a flowchart diagram illustrating a method for performing unified TCI state indication for multi-TRP downlink operation using single DCI in a wireless communication system, at least according to some embodiments. Aspects of the method of FIG. 5 may allow the UE and network to each determine the same TCI state(s) for downlink communication, e.g., of data (e.g., PDSCH), control information (e.g., PDCCH), and/or reference signals (e.g., CSI-RS, CSI-IM, etc.). The method of FIG. 5 may be useful in sDCI mTRP scenarios, among various possibilities.

Aspects of the method of FIG. 5 may be implemented by a wireless device, e.g., in conjunction with one or more cellular base stations and/or TRPs, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

The wireless device may establish a wireless link with a cellular network (502), according to some embodiments. According to some embodiments, the wireless link may include a cellular link according to 5G NR. For example, the UE may establish a session with an AMF entity of the cellular network by way of one or more base stations (e.g., TRPs and/or gNBs) that provide radio access to the cellular network. As another possibility, the wireless link may include a cellular link according to LTE. Other types of cellular links are also possible, and the cellular network may also or alternatively operate according to another cellular communication technology (e.g., UMTS. CDMA2000, GSM, etc.), according to various embodiments.

Establishing the wireless link may include establishing a radio resource control (RRC) connection with a serving cellular base station, at least according to some embodiments. Establishing the RRC connection may include configuring various parameters for communication between the UE and the cellular base station, establishing context information for the UE, and/or any of various other possible features, e.g., relating to establishing an air interface for the UE to perform cellular communication with a cellular network associated with the cellular base station. After establishing the RRC connection, the UE may operate in a RRC connected state. In some instances, the RRC connection may also be released (e.g., after a certain period of inactivity with respect to data communication), in which case the UE may operate in a RRC idle state or a RRC inactive state. In some instances, the UE may perform handover (e.g., while in RRC connected mode) or cell re-selection (e.g., while in RRC idle or RRC inactive mode) to a new serving cell, e.g., due to UE mobility, changing wireless medium conditions, and/or for any of various other possible reasons.

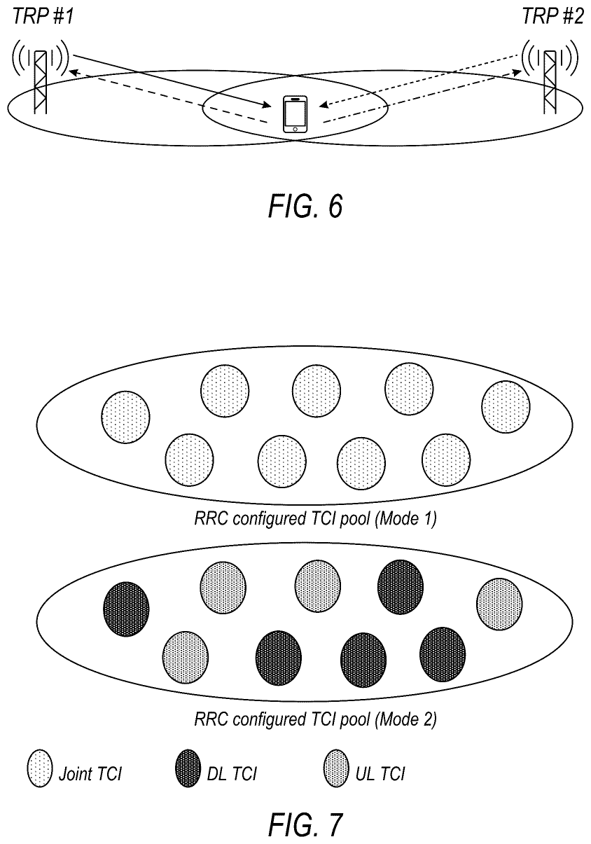

At least according to some embodiments, the UE may establish multiple wireless links, e.g., with multiple TRPs of the cellular network, according to a multi-TRP configuration. FIG. 6 illustrates a UE with wireless links with two TRPs, according to some embodiments. It will be appreciated that these links may involve several (e.g., unified) TCI states. For example, the UE may use a first DL TCI and a first UL TCI with TRP #1 and a second DL TCI and a second UL TCI with TRP #2. It will be appreciated that the UE may alternatively use a joint TCI state with one or both TRPs, e.g., a first joint TCI state with TRP #1 and a second joint TCI state with TRP #2. TRPs #1 and #2 may be associated with the same or different base station(s). TRPs #1 and #2 may be associated with the same or different cell(s).

At least in some instances, establishing the wireless link(s) may include activating a multi-TRP communication scheme. For example, any of the schemes discussed above or otherwise supported by NR (e.g., Rel. 16, Rel. 17, and/or later releases) may be used as desired.

At least in some instances, establishing the wireless link(s) may include the UE providing capability and/or preference information for the UE. Such information may include information relating to any of a variety of types of UE capabilities/preferences. At least in some instances, establishing the wireless link(s) may include the UE exchanging configuration information with the network. Among various possibilities, the configuration information, preference and/or capability information may include information related to indication (e.g., activation, deactivation, and/or selection) of one or more TCI state for communication. For example, the UE may indicate a preference for a preferred mode or configuration for selection of TCI states, among various possibilities.

The network may configure TCI states (503), according to some embodiments. The TCI states may be organized in one or more list or pool. For example, Rel-17 unified TCI state framework may support two modes:
mode 1: Joint TCI, e.g., single TCI applicable to both DL and UL; and
mode 2: Separate TCI, e.g., DL TCI used for DL and UL TCI used for UL.

For example, to support these two modes of unified TCI, the network may configure one or two lists or pools of TCI states, e.g.,: 1) a list of states that may be used for joint and/or DL (e.g., dl-OrJoint-TCIStateList); and 2) a list of UL only states (e.g., ul-TCI-StateList). FIG. 7 illustrates two such TCI pools, according to some embodiments. As shown, according to mode 1, a group of joint TCI states may be configured. According to mode 2, a group of TCI states including both DL and UL TCI states may be configured.

The TCI states in a list/pool may correspond to communications between the UE and one or multiple TRPs, e.g., TRPs #1 and #2 as in FIG. 6, or potentially more than two TRPs. The TCI states may include UL, DL, and/or joint TCI states associated with the TRP(s).

The configuration of a TCI state may include or describe features such as a quasi co-location (QCL) relationship. QCL parameters (e.g., Doppler shift, Doppler spread, average delay, delay spread, spatial Rx filter, etc.), precoding index, beam, antenna weighting, and/or relative phases of different antennas, among various possibilities. Individual TCI states may be identified by index values.

The network may indicate the configured TCI states to the UE (504), according to some embodiments. For example, the network may transmit configuration information to the UE, e.g., via RRC, describing the TCI states. The TCI states may or may not be grouped in lists/pools in the configuration information. The UE may receive the indication and may configure the TCI states.

It will be appreciated that the configuration of TCI states (e.g., in 503 and 504) may be distinct from the activation (e.g., and/or deactivation) and selection of TCI states. Activation of TCI states is discussed further below with respect to 510 and 512. Selection of TCI states is discussed further below with respect to 514, 522, and 526. For example, in 503 and 504 a plurality of TCI states may be configured. A subset of those states may be activated (e.g., in 510 and 512), e.g., semi-statically or dynamically. Then a further subset may be selected (e.g., dynamically) for a particular communication (e.g., in 514, 522, and 526).

The network may determine TCI configuration and/or mode information (506), according to some embodiments. The configuration and/or mode information may apply to DL communication. The network may determine the configuration and/or mode information for any or all of data communication (e.g., PDSCH), transmission of downlink control information (DCI) (e.g., PDCCH), and/or provision of DL reference signals (e.g., CSI-RS, CSI-IM, etc.). For example, modes/configurations for these types of communication may be determined together (e.g., they may be the same or similar) and/or separately (e.g., they may be independent of each other, regardless of whether or not they are similar. Further, mode/configuration may be determined for various more specific types of communications, such as PDSCH scheduled via dynamic grant, semi-persistent PDSCH, different types/uses of CSI-RS, etc. Again, these may be determined together and/or separately.

The configuration and/or mode information may be useable for the UE and the network to determine (e.g., dynamically) which TCI state(s) may be used for a particular DL communication/transmission. In other words, the UE and/or network may use the configuration and/or mode information (e.g., during later steps such as 514, 522, 526, etc.) to select the TCI state(s) to be used to transmit/receive/monitor one or more DL transmission(s). As further discussed below, the UE and network may also use additional information to select the TCI state(s); thus, it will be appreciated that the mode/configuration information may be distinct from one or more TCI state(s). Note that the selected TCI state(s) may be of any combination of types. For example, when two unified TCI states are indicated for (e.g., single-DCI) multi-TRP DL operation, the two unified TCI states may be any of the following options: two joint TCI states: two separate DL (e.g., DL-only) TCI states: or one joint TCI state and one separate DL TCI state. Similarly, other numbers of TCI states (e.g., one, three, or more) may be selected, in any combination of types.

It will be appreciated that the network may determine the configuration and/or mode information based on any of various factors. As one possibility, the configuration/mode may be set in standards (e.g., 3GPP). As another possibility, the configuration may be selected based on location of the UE, network traffic, other configurations of the UE, motion of the UE, capability/preferences of the UE, etc. The configuration and/or mode information may be changed from time to time, e.g., periodically and/or as needed.

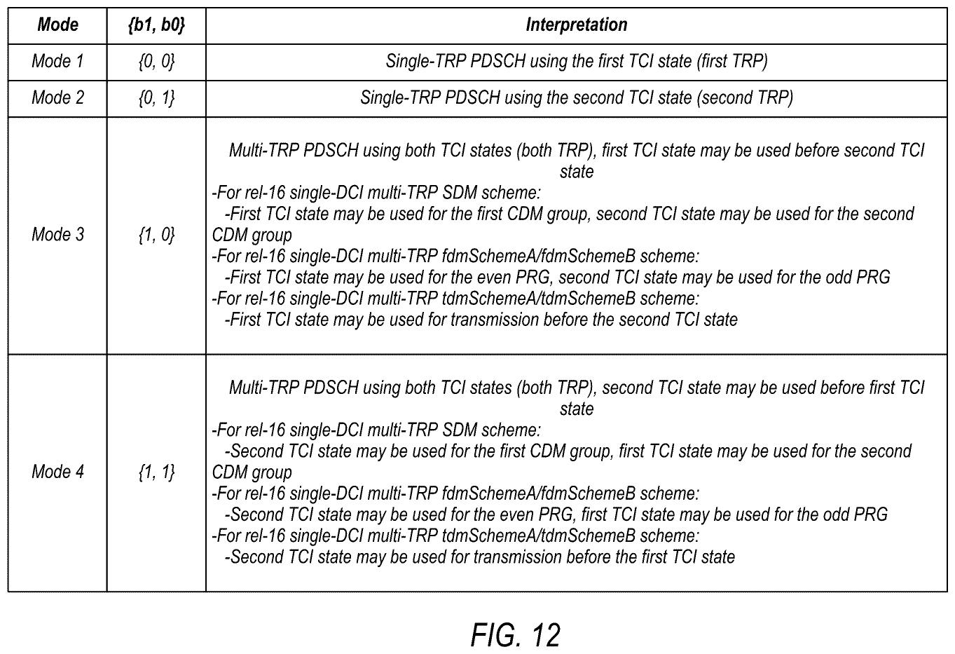

As one possibility, the configuration and/or mode information may include a selection of one mode of a plurality of modes. Note that same or different modes may be selected for different types of communication (e.g., PDSCH and PDCCH may use same or different modes). In some embodiments, there may be 4 modes. FIG. 12 illustrates four modes and their indication, according to some embodiments. As shown, a mode may be indicated using a 2 bit indication (e.g., {b1, b0}). The indication of a mode is further discussed below. As one possibility, the configuration and/or mode information may directly indicate the mode(s) to be used for one or more type of communication. As another possibility, the configuration and/or mode information may indicate a signaling approach for how/when mode may be indicated. For example, the configuration and/or mode information may specify that the mode may be indicated by one or more of RRC, media access control (MAC) control element (MAC-CE), and/or DCI signaling.

Two of the four modes may include selecting a single TCI state for the DL transmission. The particular TCI state selected may depend on an ordering of active (e.g., DL or joint) TCI states. In other words, one of the modes (e.g., mode 1) may include selecting the first TCI state according to the ordering and another one of the modes (e.g., mode 2) may include selecting the last TCI state according to the ordering.

As one possibility, the active TCI states may be ordered based on TCI state index values. For example, according to mode 1, a TCI state with a lowest TCI state index may be selected while according to mode 2 a TCI state with a highest TCI state index may be selected. As another possibility, the active TCI states may be ordered based on an order of TCI states in an indication of active TCI states (note activation of TCI states is discussed further below with respect to 510 and 512). For example, a message indicating a list of active (e.g., for DL) TCI states may include index values of a number of TCI states in a sequential order. This order may be used to select the active TCI state(s). Other means of ordering TCI states may be used as desired.

Two of the four modes may include selecting two TCI states for the DL transmission. Similar to the modes discussed above, the TCI states may be selected according to an ordering of active (e.g., DL or joint) TCI states. In other words, one of the modes (e.g., mode 3) may include selecting the first two TCI states according to the ordering and another one of the modes (e.g., mode 4) may include selecting the last two TCI states according to the ordering.

Further, according to these modes, the different TCI states may be used differently according to the ordering. How they are used differently, may depend on an active multi-TRP scheme. For example, the different TCI states that are selected may be used according to the ordering for different TDM, FDM, and/or code division multiplexing (CDM) aspects of the DL transmission. In the case of mode 3, for example, a first TCI state may be used for a first/lowest CDM group (e.g., in the case of CDM), first/lowest physical resource group (PRG) or lower frequency (e.g., in the case of FDM), and/or a first transmission in time (e.g., in the case of TDM). The second TCI state may be used for the second CDM group, PRG/frequency, and/or transmission in time. In the case of mode 4, the relation may be reversed. In other words, a last TCI state may be used for a first CDM group, first PRG, and/or a first transmission in time, and the second to last TCI state may be used for the second CDM group. PRG/frequency, and/or transmission in time.

It will be appreciated that additional modes may be used as desired. For example, if more than 2 TCI states may be used for a DL communication, then additional modes may be used. However, similar principles (e.g., different modes for different numbers of TCI states, with states selected based on ordering) may be applied to describe the relevant modes. For example, mode 3 as discussed above may be extended to include selecting the first three TCI states, e.g., according to any desired means of ordering TCI states. Similarly, additional bits may be used to indicate modes according to the number of possible modes in use.

Note that a mode may be a means/approach for determining/selecting a TCI state(s), according to some embodiments. Accordingly, determining a mode may be distinct from determining the TCI state(s).

Aspects of configuration and/or mode information for various types of DL communication are addressed below.

First, consider shared channel communication such as dynamic grant (DG) PDSCH. When two unified TCI states are activated/indicated for single-DCI multi-TRP DL operation, for DG PDSCH that is scheduled by DCI (e.g., format 1_1, or 1_2), a signaling (e.g., RRC. MAC-CE. DCI, etc.) solution may be introduced to toggle/change between the modes. In this example, the modes discussed above may be described as: mode 1: single TRP DL operation using the first unified TCI state (first TRP): mode 2: Single TRP DL operation using the second unified TCI state (second TRP): mode 3: multi-TRP DL operation using both unified TCI states (e.g., the first TCI state transmitted preceding the second TCI state); and mode 4: multi-TRP DL operation using both unified TCI states (e.g., the second TCI state transmitted preceding the first TCI state). Note that, for this purpose, preceding may include a lower CDM group, lower PRG or lower frequency, and/or earlier in time.

As mentioned above, the configuration and/or mode information may include specification of how/when a mode may be indicated. As one possibility. RRC signaling may be used to select/indicate a mode. As another possibility. MAC-CE signaling may be used. As another possibility, an indication in DCI may be used. The indication may be included in a scheduling DCI and/or in a different DCI. For example, when two unified TCI states are activated/indicated for single-DCI multi-TRP DL operation, for DG PDSCH that is scheduled by the DCI (Format 1_1, or 1_2), two bits, e.g., {b1, b0} may be introduced in the scheduling DCI. The two-bit indication may be introduced either as a new field or reusing an existing field. The interpretation of {b1, b0} may be as shown in FIG. 12. A similar indication may be used in an RRC message and/or MAC-CE.

Further, depending on an active multi-TRP scheme, modes 3 and 4 may have some additional similarities. For example, when PDSCH is configured with sfnSchemePDSCH=“sfnSchemeA”, modes 3 and 4 may have the same meaning. Accordingly, the indication for mode 4 (e.g., {1,1}) may be reserved.

Similarly, when PDSCH is configured with sfnSchemePDSCH=“sfnSchemeB”, modes 3 and 4 may have the same or similar meaning. Thus, in a first option the indication for mode 4 (e.g., {1,1}) may be reserved. However, in some embodiments (e.g., according to a second option), the different indications may be used to indicate which TRP may perform frequency compensation. For example, an indication {1, 0} may indicate that a first TRP (e.g., associated with the first TCI) may perform frequency compensation. Accordingly, the QCL parameters (e.g., Doppler shift and/or Doppler spread) may be dropped from the first TCI state. Similarly, an indication {1, 1} may indicate that a second/last TRP may perform frequency compensation and the QCL parameters may be dropped from the second TCI state.

Further, consider semi-persistently scheduled (SPS) shared channel communication, such as PDSCH. Similar to DG PDSCH, when two unified TCI states are activated/indicated for single-DCI multi-TRP DL operation, for SPS PDSCH (e.g., activated by the DCI format 1_1, or 1_2), similar solutions as discussed above for DG PDSCH may be used. The network may determine separate/independent configuration and/or mode information DG PDSCH and SPS PDSCH.

Further, consider control information communication such as PDCCH. A UE may monitor (e.g., according to a resource group such as a control resource group (CORESET) or search space set (SSS)) for PDCCH without prior knowledge about whether PDCCH may arrive. Thus, configuration and/or mode information for PDCCH may involve different and/or additional considerations relative to PDSCH.

The configuration and/or mode information for PDCCH may be configured on a per resource group or per resource group pool basis. For example, the configuration and/or mode information may be determined per CORESET, per SSS, per group/pool of CORESETs, and/or per group/pool of SSSs. Similarly, as discussed above regarding PDSCH, the configuration and/or mode information may include an indication of whether/how TCI state modes may be configured. Various examples for whether/how TCI state modes may be configured are discussed below.

In some embodiments, when multiple unified TCI states are activated/indicated for multi-TRP DL operation, the TCI state configuration/indication for PDCCH may be performed via RRC.

As one possibility for RRC configured resource groups (e.g., CORESET or SSS), the network may configure whether the corresponding resource group will follow the first TCI state, the second TCI state, etc. Note that first and second/last TCI state (and similar terms) may refer to TCI state ordering based on index, inclusion in an activation message, or other ordering system (see ordering discussion above with respect to PDSCH). A resource group may be configured with multiple TCI states. In the case that multiple TCI states are configured for a resource group, the UE may monitor them simultaneously, e.g., on the same frequencies and/or at the same time. Alternatively, one resource group may be monitored for some times and/or some frequency and other resource groups may be monitored at other times and/or other frequency (e.g., with order considerations as discussed above regarding PDSCH with respect to modes 3 and 4).

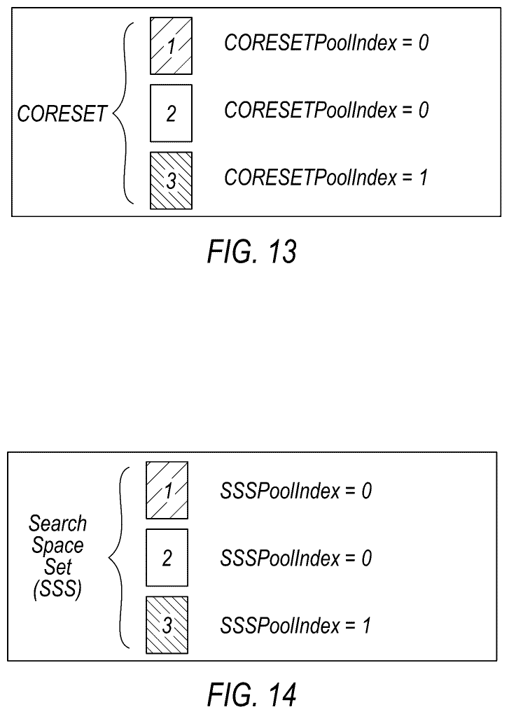

As another possibility for resource groups configured by RRC, two or more pools of resource groups may be configured. FIG. 13 illustrates CORESETs grouped into pools and FIG. 14 illustrates SSSs grouped into pools, according to some embodiments. As shown, three resource groups (1-3) may be grouped into two pools (e.g., with pool index values 0 and 1), according to some embodiments. Different groupings may be used as desired, e.g., including for more pools and/or resource groups.

Resource group pools may be configured as discussed above for individual resource groups. For example, resource groups in the first pool may use the first TCI state, resource groups in the second pool may use the second TCI state, etc. A resource group may be in multiple pools, e.g., meaning that resource groups in this pool may be configured with multiple TCI states. Similarly, a resource group pool may be configured with multiple TCI states. Again, the UE may monitor such resource groups simultaneously and/or according to multiplexing and order considerations as discussed above.

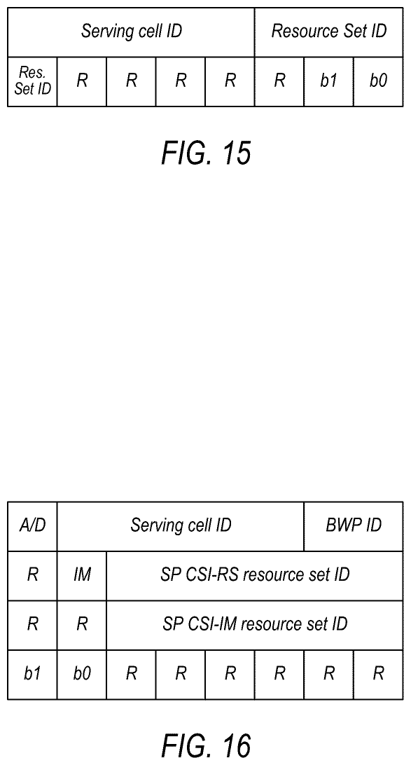

In some embodiments, when multiple unified TCI states are activated/indicated for multi-TRP DL operation, the TCI state configuration/indication for PDCCH may be performed via MAC-CE. FIG. 15 illustrates a MAC-CE that may be used to provide such an indication of the TCI configuration and/or mode information for a resource group, according to some embodiments. The MAC-CE may include a 5-bit identifier (ID) of a serving cell, e.g., for which the MAC CE applies. The MAC-CE may include a 4-bit ID of the resource group (e.g., CORESET or SSS) or resource group pool (e.g., resource group ID), e.g., for which the MAC CE applies. R may indicate reserved bits. In some embodiments, additional bits may be added (or reserved bits may be used) to indicate one or more additional resource group ID for which the MAC CE applies. Further, the MAC-CE may include two or more bits (e.g., {b1, b0}) to indicate a mode for the resource group (e.g., or sets or pool(s)). For example, similar to the examples above. {0, 0)} may indicate mode 1 and the first TCI state may be used: {0, 1} may indicate mode 2 and the last TCI state may be used; and {1, 0} and {1, 1} may indicate that multiple TCI states are used. Similar to the PDSCH examples, when PDCCH is configured with sfnSchemePDCCH=“sfnSchemeB”, {1, 0)} and {1, 1} may have similar or same meanings. As a first possibility, the QCL parameters {Doppler shift and/or Doppler spread} may be dropped from the second/last TCI state. As a second possibility, {1, 0} may indicate that the QCL parameters are dropped from the first TCI state while {1, 1} may indicate that the QCL parameters are dropped from the second/last TCI state.

Further, consider reference signal communication such as CSI-RS. CSI-RS, e.g., non-zero-power CSI-RS (NZP-CSI-RS-Resource), may be categorized in at least two different ways. For example, CSI-RS may be categorized based on usage as: CSI-RS for tracking (e.g., tracking RS (TRS)): CSI-RS for CSI: or CSI-RS for beam management (BM). Additionally, CSI-RS may be categorized based on time domain behavior as: periodic CSI-RS, semi-persistent (SP) CSI-RS, or aperiodic CSI-RS

When two or more unified TCI states are activated/indicated for multi-TRP DL operation, for aperiodic CSI-RS, TCI state mode may be indicated by RRC (e.g., in 506/508 and/or subsequently). For example, a new 1-bit field may be introduced in an information element (IE) such as CSI-AssociatedReportConfigInfo. The new 1-bit field may be a unifiedTCI_index field, as shown in the example below:

CSI-AssociatedReportConfigInfo ::= SEQUENCE {
reportConfigId CSI-ReportConfigId,
unifiedTCI_index ENUMERATED {0, 1} Optional
...
}

The 1-bit field may be an indication similar to indicating one of the first or second modes discussed above. For example, if the 1-bit field is 0, mode 1 may be indicated (e.g., the first TCI state may be used) and if the 1-bit field is 1, mode 2 may be indicated (e.g., the second/last TCI state may be used). Note that first and second/last TCI state (and similar terms) may refer to TCI state ordering based on index, inclusion in an activation message, or other ordering system (see ordering discussion above with respect to PDSCH). Additional bits may be used as desired, e.g., to indicate appropriate modes (or TCI state(s)) if more specificity is desired associated with selecting one or more TCI states. For example, modes could be indicated to select multiple TCI states and/or TCI state(s) in other positions in an ordered list of TCI states.

Note that the above approach for aperiodic CSI-RS may not apply to aperiodic CSI-RS for tracking (TRS).

As another possibility, when two or more unified TCI states are activated/indicated for multi-TRP DL operation, for aperiodic CSI-RS, TCI state mode may be indicated by DCI (e.g., in 506/508 and/or subsequently). For example, a new 1-bit field may be introduced in a DCI message. The 1-bit field may be an indication similar to indicating one of the first or second modes discussed above. For example, if the 1-bit field is 0, mode 1 may be indicated (e.g., the first TCI state may be used) and if the 1-bit field is 1, mode 2 may be indicated (e.g., the second/last TCI state may be used). Note that first and second/last TCI state (and similar terms) may refer to TCI state ordering based on index, inclusion in an activation message, or other ordering system (see ordering discussion above with respect to PDSCH). Additional bits may be used as desired, e.g., to indicate appropriate modes (or TCI state(s)) if more specificity is desired associated with selecting one or more TCI states. For example, modes could be indicated to select multiple TCI states and/or TCI state(s) in other positions in an ordered list of TCI states.

When two or more unified TCI states are activated/indicated for multi-TRP DL operation, for periodic CSIRS, TCI state mode may be indicated by RRC (e.g., in 506/508 and/or subsequently). For example, a new 1-bit field (e.g., unifiedTCI_index) may be introduced in an IE such as NZP-CSI-RS-Resource, as shown in the example below:

NZP-CSI-RS-Resource ::= SEQUENCE {
nzp-CSI-RS-ResourceId NZP-CSI-RS-ResourceId,
resourceMapping CSI-RS-ResourceMapping,
powerControlOffset INTEGER (−8..15),
powerControlOffsetSS ENUMERATED {db−3, db0, db3, db6} OPTIONAL, -- Need R
scramblingID ScramblingId,
periodicityAndOffset CSI-ResourcePeriodicityAndOffset OPTIONAL, -- Cond
PeriodicOrSemiPersistent
qcl-InfoPeriodicCSI-RS TCI-StateId OPTIONAL, -- Cond Periodic
unifiedTCI_index ENUMERATED {0, 1} Optional, -- Cond Periodic
...
}

Similar to aperiodic CSI-RS, the 1-bit field may be an indication similar to indicating one of the first or second modes discussed above. For example, if the 1-bit field is 0, mode 1 may be indicated (e.g., the first TCI state may be used) and if the 1-bit field is 1, mode 2 may be indicated (e.g., the second/last TCI state may be used). Again, additional bits may be used as desired.

When two or more unified TCI states are activated/indicated for multi-TRP DL operation, for semi persistent (SP) CSI-RS, TCI state mode information may be signaled by MAC-CE. The modes (e.g., which may later be indicated by MAC-CE) may be determined/described in the TCI configuration and/or mode information. FIG. 16 illustrates an enhanced MAC-CE which may be introduced for semi persistent CSI-RS, according to some embodiments. A field “A/D” may indicate whether to activate or deactivate indicated SP CSI-RS and/or CSI-IM resource set(s). A 5-bit serving cell ID field may indicate the serving cell for which the MAC CE applies. A 2-bit bandwidth part (BWP) ID may indicate the BWP for which the MAC CE applies. An IM field may indicate the presence (or absence) of an SP CSI-IM resource set. An SP CSI-RS resource set ID field may indicate the ID of SP CSI-RS resource set and an SP CSI-IM resource set ID field may indicate the ID of SP CSI-IM resource set. One or more reserved bits (R) may be included. Similar to CSI examples above. 1-bit indicators may be included to indicate a mode for each of SP-CSI-RS and SP-CSI IM. (e.g., {b1, b0}). For example, b1 may indicate a mode for SP CSI-RS resource set and b0 may indicate a mode for SP CSI-IM resource set, if indicated (e.g., if no CSI-IM is indicated in the IM field and/or CSI-IM resource set ID field, then b0 may be omitted). For either of b0 or b1, the interpretations may be as discussed above, e.g., 0 may indicate the first activated/indicated TCI state may be used and 1 may indicate that the second/last activated/indicated TCI state may be used.

It will be appreciated that various bit values (e.g., {b0, b1}) and associated interpretations are discussed herein, however these are examples. Other interpretations of bit values (e.g., interpretations of b1 and b0 may be reversed, etc.) and/or other forms of indication (e.g., including more or fewer bits) may be used as desired.

The network may transmit one or more indication(s) of the TCI configuration and/or mode information to the UE (508), according to some embodiments. The network may transmit the TCI configuration and/or mode information using any type or combination of types of signaling and any number of messages. For example, the network may use RRC. MAC-CE, and/or DCI signaling. The network may transmit the TCI configuration and/or mode information in any number of parts. For example, different messages may carry information for different types of DL communications. Multiple messages may be used to carry information about a same type of DL communication.

The network may transmit the TCI configuration and/or mode information at the same time (e.g., in the same or different message) as the TCI states (e.g., in 504) and/or the indication of TCI state activation (e.g., 512), and/or at a different time(s). Similarly, the TCI configuration and/or mode information may be transmitted with other information. For example, TCI configuration and/or mode information (e.g., or parts of the information related to resource groups) may be transmitted with configurations of resource groups. Similarly. TCI configuration and/or mode information (e.g., or parts of the information related to reference signals) may be transmitted with configurations of reference signals. For example, such information may be transmitted in a same RRC IE or MAC-CE.

The UE may receive the TCI configuration and/or mode information.

Among various possibilities, the methods of transmitting and receiving the TCI configuration and/or mode information may be summarized as follows. For configuration and/or mode information for PDSCH: any combination of RRC, MAC-CE, and/or DCI may be used as desired. For configuration and/or mode information for PDCCH, RRC and/or MAC-CE may be used. For configuration and/or mode information for PDSCH: any combination of RRC, MAC-CE, and/or DCI may be used as desired. One example approach for different types of CSI-RS may be: RRC for periodic CSI-RS, MAC-CE for semi-persistent CSI-RS, and DCI for aperiodic CSI-RS. However, embodiments and methods different from those summarized in this paragraph may be used as desired.

The network may select one or more TCI state(s) to activate (510), according to some embodiments. For example, the network may determine to modify a list of active TCI states (e.g., by adding and/or subtracting active TCI states), maintain (e.g., without change) a list of active TCI states, and/or create a new list of active TCI states. The network may select the TCI state(s) based on any combination of factors such as location and/or motion of the UE, measurements reported by the UE, measurements performed at one or more TRPs, preferences reported by the UE, etc.

In some embodiments, the network may activate different TCI states (or different groups of TCI states) for different types of communications. For example, the network may activate one state or group of TCI states for PDSCH/data communications and another state or group of TCI states (e.g., including the same or a different number of TCI states) for reference signals, etc.

The network may indicate the active TCI state(s) to the UE (512), according to some embodiments. The network may transmit one or more indication(s) of the active (and/or deactivated) TCI state(s) using any type or combination of types of signaling. For example, the network may use RRC, MAC-CE, and/or DCI signaling. The network may transmit the indication(s) of TCI state(s) at the same time (e.g., in the same or different message) as the configuration of the TCI states (e.g., in 504) and/or the indication of TCI configuration and/or mode information (e.g., in 512), and/or at a different time(s). Various possibilities for the indication of active TCI state(s) are discussed further below.

In Rel-17, for unified TCI framework, two solutions may be supported for TCI indication/activation: 1) MAC-CE based, and 2) MAC-CE+DCI based.

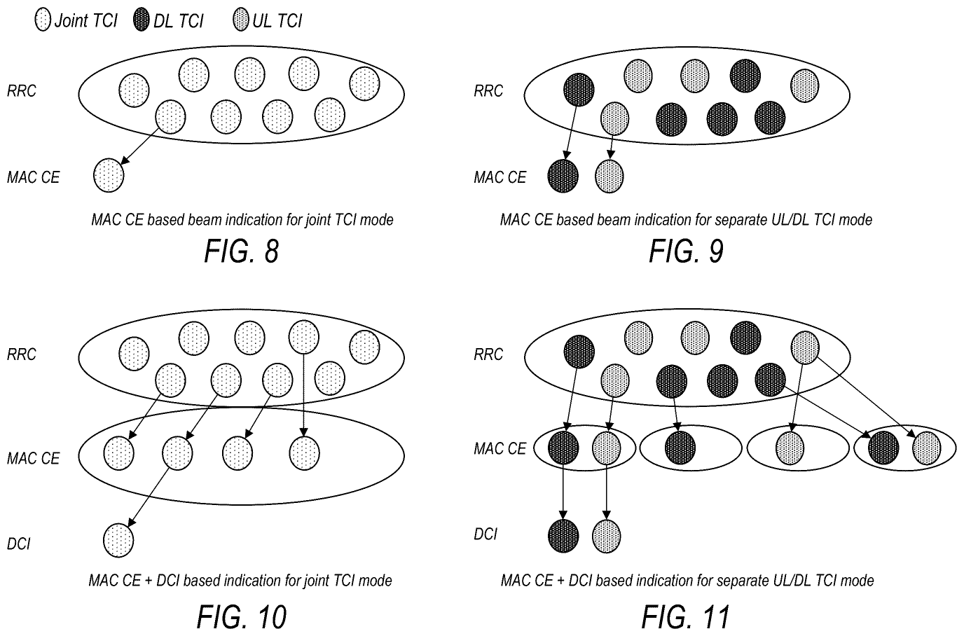

FIG. 8 illustrates a process of indicating active TCI states by MAC-CE in context of a joint TCI mode, according to some embodiments. As shown, a pool of TCI states may be configured by RRC (e.g., in 503, 504). Then (e.g., in 510, 512), the network may determine one or more of these TCI states to be active and may transmit a MAC-CE to the UE to indicate that the TCI state(s) is/are active. In context of a single TRP mode, the UE may use the (e.g., single) active TCI state for subsequent communications, e.g., until the active TCI is changed. In context of a multi-TRP mode, the UE may consider multiple TCI states active based on the MAC-CE, and may determine which of the active TCI states to use at a particular time or for a particular communication as further discussed herein.

FIG. 9 illustrates a process of indicating active TCI states by MAC-CE in context of a separate TCI mode, according to some embodiments. As shown, a pool of TCI states may be configured by RRC (e.g., in 503, 504). Then (e.g., in 510, 512), the network may determine one or more UL TCI states and one or more DL TCI states and transmit a MAC-CE to the UE to indicate that the selected TCI state(s) are active. In context of a single TRP mode, the UE may use the (e.g., single) active DL TCI state for subsequent DL communications, e.g., until the active DL TCI is changed. The same may be true for UL (e.g., which may be a different TCI). In context of a multi-TRP mode, the UE may consider multiple DL TCI states active based on the MAC-CE, and may determine which of the active DL TCI states to use at a particular time or for a particular communication as further discussed herein. Similarly, multiple UL TCI states may be considered active, according to some embodiments.

FIG. 10 illustrates a process of indicating active TCI states by MAC-CE and DCI in context of a joint TCI mode, according to some embodiments. As shown, a pool of TCI states may be configured by RRC (e.g., in 503, 504). Then (e.g., in 510, 512), the network may determine one or more of these TCI states and transmit a MAC-CE to the UE to indicate that the TCI state(s) is/are active. The MAC-CE may set codepoints for the active TCI states. A subsequent DCI message may indicate one or more of the codepoints and the UE may treat the TCI state(s) corresponding to the indicated codepoint(s) as active. In some embodiments, one codepoint may correspond to more than one TCI state, thus by indicating a single codepoint, the network may activate more than one joint TCI state (and the UE may correspondingly activate the TCI states).

FIG. 11 illustrates a process of indicating active TCI states by MAC-CE and DCI in context of a separate TCI mode, according to some embodiments. As shown, a pool of TCI states may be configured by RRC (e.g., in 503, 504). Then (e.g., in 510, 512), the network may determine one or more UL TCI states and one or more DL TCI states and transmit a MAC-CE to the UE to indicate that the TCI state(s) is/are active. The MAC-CE may set codepoints for the active TCI state(s). A subsequent DCI message may indicate one or more of the codepoints and the UE may treat the TCI state(s) corresponding to the indicated codepoint(s) as active. As noted above, one codepoint may correspond to more than one (e.g., joint, DL and/or UL) TCI state.

The UE may receive the indication(s) and may treat the corresponding TCI state(s) as active.

The UE and network may determine one or more TCI state(s) to monitor/use for control information (514), according to some embodiments. The UE and network may each (e.g., independently of each other) make the same determination/selection of TCI state(s).

The UE and/or network may consider the TCI configuration and/or mode information (e.g., discussed with respect to 506 and 508) and/or the active DL or joint TCI state(s) (e.g., discussed with respect to 510 and 512). To the extent that the TCI configuration and/or mode information and/or the active DL or joint TCI state(s) include information and/or state(s) indicated for receiving/monitoring PDCCH or control information, the UE and/or network may specifically consider the relevant information and/or state(s).

For example, the UE and/or network may determine a mode for selecting TCI state(s) for control channel monitoring according to the TCI configuration and/or mode information. The mode may be any of the modes discussed above for control information, among various possibilities. Based on the mode and the active (e.g., DL or joint) TCI state(s), the UE and/or network may determine one or more TCI state(s) for control channel monitoring/transmission.

For example, as discussed above, the UE and/or network may order the active (e.g., DL or joint) TCI state(s). Then, the UE and/or network may select one or more of the active TCI states based on the order. The mode and/or selection (e.g., first or last, etc.) may be as configured for a particular resource group (e.g., CORESET, SSS) or resource group pool, e.g., in the TCI configuration and/or mode information. For example, in one mode, the UE and/or network may select the first TCI state for the resource group (according to the order). Alternatively, (e.g., in a different mode or as configured for the resource group), the UE may select multiple TCI states (e.g., first and second, etc., according to the order).

The UE may monitor for control information (515), according to some embodiments. For example, at the time/frequency resources associated with a resource group for which the UE is configured to monitor for control information, the UE may monitor the TCI state(s) determined (e.g., in 514). The UE may monitor a control channel such as PDCCH. To monitor the TCI state(s), the UE may tune its antenna(s) and/other receive and/or transmit circuitry according to the TCI state(s).

In some embodiments, during the monitoring, the UE may adjust for QCL parameters (e.g., Doppler shift and/or spread) or may not, e.g., according to whether or not the QCL parameters are dropped for a corresponding TCI state. For example, when PDCCH is configured in sfnSchemeB mode, the QCL properties of {Doppler spread, Doppler shift} may be dropped from a first TCI state (e.g., associated with a first TRP) in order to account for the frequency compensation performed at different TRP. For example, the first TRP and/or UE may not adjust for Doppler spread or Doppler shift when transmitting and/or receiving with the first TCI state. A second TRP and/or the UE may adjust for Doppler spread or Doppler shift when transmitting and/or receiving with a second TCI state (e.g., associated with the second TRP). For which state the QCL parameters are dropped may depend on the TCI configuration and/or mode information (e.g., {b1, b0} in a MAC-CE associated with a relevant resource group).

It will be appreciated that the UE may monitor one or multiple resource groups. For different resource groups, the UE may monitor the same or different TCI state(s).

In some embodiments, one or more resource groups may be associated with multiple TCI states per resource group (e.g., determined according to the configuration and/or mode information). For such resource groups, the UE may monitor all of the associated TCI states.

The network may transmit control information to the UE (516), according to some embodiments. For example, at any time/frequency resources associated with a resource group for which the UE is configured to monitor for control information, the network may transmit using the TCI state(s) determined (e.g., in 514). To transmit using the TCI state(s), the network may tune its antenna(s) and/other receive and/or transmit circuitry (e.g., at one or more TRP) according to the TCI state(s). The control information may be transmitted on a control channel such as PDCCH.

In some embodiments, during a transmission, the network may adjust for QCL parameters (e.g., Doppler shift and/or spread) or may not, e.g., according to whether or not the QCL parameters are dropped for a corresponding TCI state.

It will be appreciated that the network may transmit control information on one or multiple resource groups. For different resource groups, the network may use the same or different TCI state(s).

In some embodiments, one or more resource groups may be associated with multiple TCI states per resource group (e.g., determined according to the configuration and/or mode information). For such resource groups, the network may transmit on any or all of the associated TCI states.

The UE may receive the control information. The control information may include one or more DCI messages.

The network may schedule a first shared channel communication (518), according to some embodiments. For example, the first shared channel communication may be a DL data communication, e.g., communicated via PDSCH. The first shared channel communication may be scheduled via dynamic grant (DG) and/or semi-statically (e.g., SPS PDSCH).

The network may transmit a grant or other scheduling message to the UE to schedule the first shared channel transmission. The grant/scheduling message may be transmitted in 516 and/or at a different time.

The UE and network may determine one or more TCI state(s) to for the first shared channel communication (522), according to some embodiments. The UE and network may each (e.g., independently of each other) make the same determination/selection of TCI state(s).

The UE and/or network may consider the TCI configuration and/or mode information (e.g., discussed with respect to 506 and 508) and/or the active DL or joint TCI state(s) (e.g., discussed with respect to 510 and 512). To the extent that the TCI configuration and/or mode information and/or the active DL or joint TCI state(s) include information and/or state(s) specifically for receiving data, PDSCH, and/or shared channel communications, the UE and/or network may specifically consider the relevant information and/or state(s).

In some embodiments, some or all of the TCI configuration and/or mode information (e.g., discussed with respect to 506 and 508) may be included in one or more DCI messages that schedule the first shared channel information (e.g., discussed with respect to 518). For example, as discussed above, two bits (e.g., {b1, b0}) may be included in one or more DCI message to indicate a mode for the scheduled communication (e.g., the first shared channel communication).

For example, the UE and/or network may determine a mode for selecting TCI state(s) for shared channel communication according to the TCI configuration and/or mode information. The mode may be any of the modes discussed above for shared channel communication, among various possibilities. Based on the mode and the active (e.g., DL or joint) TCI state(s), the UE and/or network may determine one or more TCI state(s) for shared channel communication.

For example, as discussed above, the UE and/or network may order the active (e.g., DL or joint) TCI state(s). Then, the UE and/or network may select one or more of the active TCI states based on the order. The mode and/or selection (e.g., first or last, etc.) may be as configured for DG PDSCH, e.g., in the TCI configuration and/or mode information. For example, in one mode, the UE and/or network may select the first TCI state (according to the order). In another mode, the UE and/or network may select the multiple TCI states (e.g., first and second, etc., according to the order) and may use different TCI states differently (e.g., for different CDM groups. PRGs/frequencies, and/or transmission times, e.g., depending on an active multi-TRP scheme).

The network may transmit the first shared channel communication to the UE (524), according to some embodiments. The UE may receive the transmission of the first shared channel communication. The network may use the selected TCI state(s) to perform the transmission and the UE may use the selected TCI state(s) to receive the transmission. To receive the transmission, the UE may tune its antenna(s) and/other receive and/or transmit circuitry according to the TCI state(s). Similarly, the network (e.g., TRP(s)) may tune corresponding antenna(s) and circuitry according to the TCI state(s) to transmit the first shared channel communication.

In some embodiments, the UE and/or network may adjust for QCL parameters (e.g., Doppler shift and/or spread) or may not, e.g., according to whether or not the QCL parameters are dropped for a corresponding TCI state. For example, when PDSCH is configured in sfnSchemeA or sfnSchemeB mode, the QCL properties of {Doppler spread. Doppler shift} may be dropped from a first TCI state (e.g., associated with a first TRP) in order to account for the frequency compensation performed at different TRP. For example, the first TRP and/or UE may not adjust for Doppler spread or Doppler shift when transmitting and/or receiving with the first TCI state. A second TRP and/or the UE may adjust for Doppler spread or Doppler shift when transmitting and/or receiving with a second TCI state (e.g., associated with the second TRP). For which state the QCL parameters are dropped may depend on the TCI configuration and/or mode information (e.g., {b1, b0} in a scheduling DCI).

The UE and/or network may determine one or more TCI state(s) to monitor for reference signals (526), according to some embodiments. The UE and network may each (e.g., independently of each other) make the same determination/selection of TCI state(s) for RS.

The UE and/or network may consider the TCI configuration and/or mode information (e.g., discussed with respect to 506 and 508) and/or the active DL or joint TCI state(s) (e.g., discussed with respect to 510 and 512). To the extent that the TCI configuration and/or mode information and/or the active DL or joint TCI state(s) include information and/or state(s) specifically for RS, the UE and/or network may specifically consider the relevant information and/or state(s).

For example, the UE and/or network may determine a mode for selecting TCI state(s) for shared channel communication according to the TCI configuration and/or mode information. The mode may be any of the modes discussed above for RS communication, among various possibilities. Based on the mode and the active (e.g., DL or joint) TCI state(s), the UE and/or network may determine one or more TCI state(s) for RS communication.

For example, as discussed above, the UE and/or network may order the active (e.g., DL or joint) TCI state(s). Then, the UE and/or network may select one or more of the active TCI states based on the order. The mode and/or selection (e.g., first or last, etc.) may be as configured for RS generally or a specific type or types of RS, e.g., in the TCI configuration and/or mode information. For example, in one mode, the UE and/or network may select the first TCI state (according to the order). In another mode, the UE and/or network may select a different TCI state (e.g., second/last, etc., according to the order).

It will be appreciated that independent determinations may be made for different types of RS (e.g., SP CSI-RS, SP CSI-IM, aperiodic CSI-RS, periodic CSI-RS, etc.). These different types may use the same or different modes and the same or different TCI state(s).

The network may transmit the reference signal(s) (528), according to some embodiments. The UE may receive the transmission of the RS. The UE may perform measurement(s), tracking, etc. based on the RS. One or more types/purposes of RS may be transmitted/received at the same and/or different times.

The network may use the selected TCI state(s) to perform the transmission and the UE may use the selected TCI state(s) to receive the transmission. To receive the transmission, the UE may tune its antenna(s) and/other receive and/or transmit circuitry according to the TCI state(s). Similarly, the network (e.g., TRP(s)) may tune corresponding antenna(s) and circuitry according to the TCI state(s) to transmit the RS.

In some embodiments, different TCI state(s) may be used for different types/purposes of RS.

In some embodiments, the UE and/or network may adjust for QCL parameters (e.g., Doppler shift and/or spread) or may not, e.g., according to whether or not the QCL parameters are dropped for a corresponding TCI state. For example, when RS are configured in sfnSchemeA or sfnSchemeB mode, the QCL properties of {Doppler spread, Doppler shift} may be dropped from a first TCI state (e.g., associated with a first TRP) in order to account for the frequency compensation performed at different TRP. For example, the first TRP and/or UE may not adjust for Doppler spread or Doppler shift when transmitting, receiving, and/or measuring with the first TCI state. A second TRP and/or the UE may adjust for Doppler spread or Doppler shift when transmitting, receiving, and/or measuring with a second TCI state (e.g., associated with the second TRP). For which state the QCL parameters are dropped may depend on the TCI configuration and/or mode information (e.g., {b1, b0} in a MAC-CE).

Thus, at least according to some embodiments, the method of FIG. 5 may be used to provide a framework according to which a UE and network may select one or more TCI state(s) (e.g., of multiple active TCI states which may be associated with multiple TRPs) for DL communication, and thus to assist the network to effectively and efficiently schedule and perform wireless communications with the UE, at least in some instances.

It will be appreciated that although various examples are provided with respect to two TCI states and/or two TRPs, the method of FIG. 5 may apply to different (e.g., larger numbers of states and/or TRPs). For example, regarding the 1- and/or 2-bit indications discussed above regarding PDCCH. PDSCH, and RS, additional bits may be used as desired, e.g., to indicate appropriate modes (or TCI state(s)) if more specificity is desired associated with selecting one or more TCI states. For example, modes could be indicated to select multiple TCI states and/or TCI state(s) in other positions in an ordered list of TCI states.

It will be appreciated that the determinations in 514, 522, and 526 are independent of each other. In other words, the same or different TCI state(s) may be used for control channel (e.g., PDCCH), shared channel/data (e.g., PDSCH), and/or reference signals (e.g., CSI-RS. CSI-IM, etc.). Further, it is noted that any of these determinations may occur simultaneously, in a different order than shown, or may be omitted. For example, the method of FIG. 5 may be performed for any one of PDCCH. PDSCH, and/or RS, and the others may be omitted (e.g., or performed differently than described herein). Similarly, if one of these determinations is omitted or reordered relative to other determinations, related steps may similarly be omitted or reordered. For example, if 522 is omitted or reordered, 518 and 524 may similarly be omitted or reordered. Still further, it will be appreciated that steps related to the individual determinations have been grouped for clarity of explanation. However, the steps may be performed in different orders or at the same time. For example, any or all of 518, 526, and 528 could occur prior to 514, etc.

It will be appreciated that the method of FIG. 5 may be applied to different BWPs, frequency ranges (FR) (e.g., NR's FR1 and FR2, etc.), cells, cell groups, RATs, networks, etc. For example, different TCI configuration and/or mode information may be determined and provided by the network (e.g., in 506, 508) and accordingly different TCI states may be selected in any of 514, 522, and/or 526 for such different BWPs, FRs, cells, cell groups, RATs, networks, etc.

It will be appreciated that any of these steps may be repeated any number of times (e.g., as a UE moves, for new transmissions, etc.).

In the following further exemplary embodiments are provided.

One set of embodiments may include a method, by a user equipment (UE). The method may include receiving, from a cellular network, configuration of a plurality of transmission configuration indication (TCI) states associated with a plurality of transmission and reception points (TRPs). The UE may receive, from the cellular network, an indication of a plurality of active TCI states for downlink (DL) communication, wherein the plurality of active TCI states comprises a subset of the plurality of TCI states. The UE may receive, from the cellular network, an indication of a first mode, of a plurality of modes, for selection of one or more TCI state for DL operation. The UE may receive, from the cellular network, a first message scheduling a first DL transmission. The UE may select, based at least in part on the first mode, a first TCI state of the plurality of active TCI states for reception of the first DL transmission; and may receive the first DL transmission from at least a first TRP of the plurality of TRPs.

In some embodiments, the plurality of active TCI states comprises at least one of: a joint TCI state: or a DL only TCI state.

In some embodiments, the indication of the first mode is received via at least one of: a radio resource control (RRC) message: or a media access control (MAC) control element (MAC-CE).

In some embodiments, the selection based on the first mode comprises selection of only one TCI state of the plurality of active TCI states for reception of the first DL transmission.

In some embodiments, the selection based on the first mode comprises selection of the first TCI state based on a TCI state index value of the first TCI state in comparison to respective TCI state index values of other TCI states of the plurality of active TCI states.

In some embodiments, the selection based on the first mode comprises selection of the first TCI state based on an order of TCI states in the indication of the plurality of active TCI states.

In some embodiments, the selection based on the first mode further comprises selection of a second TCI state of the plurality of active TCI states for reception of the first DL transmission, in addition to the first TCI state.

In some embodiments, the selection based on the first mode further comprises determining an order for use of the first TCI state relative to use of the second TCI state.

In some embodiments, the indication of the first mode comprises at least two bits in the first message.

In some embodiments, the first message comprises a DCI message.

One set of embodiments may include a method, by a user equipment (UE). The method may include receiving, from a cellular network, configuration of a plurality of transmission configuration indication (TCI) states associated with a plurality of transmission and reception points (TRPs). The UE may receive, from the cellular network, an indication of a plurality of active TCI states for downlink (DL) communication, wherein the plurality of active TCI states comprises a subset of the plurality of TCI states. The UE may receive, from the cellular network, configuration of a first resource group for DL control communication operation. The configuration of the first resource group may comprise an indication of a rule to select a TCI state for monitoring the first resource group. The UE may select, based at least in part on the configuration of the first resource group, a first TCI state of the plurality of active TCI states for monitoring the first resource group; and may monitor a control channel on the first resource group using the first TCI state.

In some embodiments, the first resource group comprises one of: a first control resource group (CORESET): or a first search space set (SSS).

In some embodiments, the indication of how to select a TCI state for monitoring the first resource group indicates to select based on a TCI state index value of the first TCI state in comparison to respective TCI state index values of other TCI states of the plurality of active TCI states.

In some embodiments, the indication of how to select a TCI state for monitoring the first resource group indicates to select based on an order of TCI states in the indication of the plurality of active TCI states.

In some embodiments, the indication of how to select a TCI state for monitoring the first resource group indicates to select more than one TCI state of the plurality of active TCI states.

In some embodiments, the configuration of the first resource group comprises configuration of a first pool of resource groups for DL control communication operation, the first pool of resource groups comprising the first resource group.

In some embodiments, the configuration of the first resource group are received via at least one of: a radio resource control (RRC) message: or a media access control (MAC) control element (MAC-CE).

One set of embodiments may include a method, by a user equipment (UE). The method may include receiving, from a cellular network, configuration of a plurality of transmission configuration indication (TCI) states associated with a plurality of transmission and reception points (TRPs). The UE may receive, from the cellular network, an indication of a plurality of active TCI states for downlink (DL) communication, wherein the plurality of active TCI states comprises a subset of the plurality of TCI states. The UE may receive, from the cellular network, an indication of a rule to select a TCI state for receiving channel state information (CSI) reference signals (CSI-RS). The UE may select, based at least in part on the rule, a first TCI state of the plurality of active TCI states for receiving CSI-RS. The UE may receive CSI-RS using the first TCI state from a first TRP of the plurality of TRPs.

In some embodiments, the method may further comprise receiving, from the cellular network, an indication of a rule to select a TCI state for receiving CSI interference measurement (CSI-IM) reference signals.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving, from a cellular network, an indication of a plurality of active transmission configuration indication (TCI) states for downlink (DL) communication, wherein the plurality of active TCI states is associated with a plurality of transmission and reception points (TRPs);
receiving, from the cellular network, an indication of a first mode, of a plurality of modes, for selection of one or more TCI state for DL operation;
receiving, from the cellular network, a first message scheduling a first DL transmission;
selecting, based at least in part on the first mode, a first TCI state of the plurality of active TCI states for reception of the first DL transmission; and
receiving the first DL transmission from at least a first TRP of the plurality of TRPs.

2. The method of claim 1, wherein the plurality of active TCI states comprises at least one of: a joint TCI state; or a DL only TCI state.

3. The method of claim 1, wherein the indication of the first mode is received via at least one of:
a radio resource control (RRC) message; or
a media access control (MAC) control element (MAC-CE).

4. The method of claim 1, wherein the selection of the first TCI state based on the first mode comprises selection of only one TCI state of the plurality of active TCI states for reception of the first DL transmission.

5. The method of claim 1, wherein the selection of the first TCI state based on the first mode comprises selection of the first TCI state based on a TCI state index value of the first TCI state in comparison to respective TCI state index values of other TCI states of the plurality of active TCI states.

6. The method of claim 1, wherein the selection of the first TCI state based on the first mode comprises selection of the first TCI state based on an order of TCI states in the indication of the plurality of active TCI states.

7. The method of claim 1, wherein the selection of the first TCI state based on the first mode further comprises selection of a second TCI state of the plurality of active TCI states for reception of the first DL transmission, in addition to the first TCI state.

8. The method of claim 7, wherein the selection of the first TCI state based on the first mode further comprises determining an order for use of the first TCI state relative to use of the second TCI state.

9. The method of claim 1, wherein the indication of the first mode comprises at least two bits in the first message.

10. A method, comprising:
receiving, from a cellular network, an indication of a plurality of active transmission configuration indication (TCI) states for downlink (DL) communication, wherein the plurality of active TCI states is associated with a plurality of transmission and reception points (TRPs);
receiving, from the cellular network, configuration of a first resource group for DL control communication operation, the configuration of the first resource group comprising an indication of a rule to select a TCI state for monitoring the first resource group;
selecting, based at least in part on the configuration of the first resource group, a first TCI state of the plurality of active TCI states for monitoring the first resource group; and
monitoring a control channel on the first resource group using the first TCI state.

11. The method of claim 10, wherein the first resource group comprises one of:
a first control resource group (CORESET); or
a first search space set (SSS).

12. The method of claim 10, wherein the indication of how to select a TCI state for monitoring the first resource group indicates to select based on a TCI state index value of the first TCI state in comparison to respective TCI state index values of other TCI states of the plurality of active TCI states.

13. The method of claim 10, wherein the indication of how to select a TCI state for monitoring the first resource group indicates to select based on an order of TCI states in the indication of the plurality of active TCI states.

14. The method of claim 10, wherein the indication of how to select a TCI state for monitoring the first resource group indicates to select more than one TCI state of the plurality of active TCI states.

15. The method of claim 10, wherein the configuration of the first resource group comprises configuration of a first pool of resource groups for DL control communication operation, the first pool of resource groups comprising the first resource group.

16. The method of claim 10, wherein the configuration of the first resource group are received via at least one of:
a radio resource control (RRC) message; or
a media access control (MAC) control element (MAC-CE).

17. An apparatus, comprising:
a processor configured to, when executing instructions stored in a memory, perform operations comprising:
receiving, from a cellular network, an indication of a plurality of active transmission configuration indication (TCI) states for downlink (DL) communication, wherein the plurality of active TCI states is associated with a plurality of transmission and reception points (TRPs);
receiving, from the cellular network, an indication of a rule to select a TCI state for receiving channel state information (CSI) reference signals (CSI-RS);
selecting, based at least in part on the rule, a first TCI state of the plurality of active TCI states for receiving CSI-RS; and
receiving CSI-RS using the first TCI state from a first TRP of the plurality of TRPs.

18. The apparatus of claim 17, wherein the operations further comprise receiving, from the cellular network, an indication of a rule to select a TCI state for receiving CSI interference measurement (CSI-IM) reference signals.

19-20. (canceled)

21. The apparatus of claim 18, wherein the TCI state is selected for at least one of:
a bandwidth part (BWP);
a frequency range (FR);
a cell;
a cell group;
a radio access technology (RAT); or
a network.

22. The apparatus of claim 17, further comprising:
a radio operably coupled to the processor.
